(19) United States
(12) Patent Application Publication
(10) Pub. No.: US 2024/0391768 A1
(43) Pub. Date: Nov. 28, 2024

(54) PARALLEL PROCESS HEATING AGAINST SERIAL COMBUSTION

(71) Applicant: Jonathan Jay Feinstein, Bridgeport, CT (US)

(72) Inventor: Jonathan Jay Feinstein, Bridgeport, CT (US)

(21) Appl. No.: 18/202,253

(22) Filed: May 25, 2023

(51) Int. Cl. C01B 3/34; F23C 6/04

(52) U.S. Cl. CPC C01B 3/34; F23C 6/042; C01B 2203/0233; C01B 2203/0822; F23C 2900/9901

(57) ABSTRACT

Compressed air is partially combusted with a fuel, cooled by counter current convection against mixed feed comprising steam and a hydrocarbon whereby the mixed feed reacts to form syngas, the air is further combusted with fuel and cooled against mixed feed, whereby the mixed feed reacts to form syngas, and the air is then expanded to perform work on a load. The mixed feed and combustion gases exchange heat counter currently at approximately the same respective pressures of 30 bar. The flame temperature, firing rate, NOx production, bridge wall temperature, and the expense of downstream heat recovery are reduced compared to radiant furnaces used for steam reforming. The radiant zone in steam reforming is replaced with smaller equipment. Steam export is eliminated.

### FIELD

The present invention pertains to the heating of fluids and, as an example, the heating of fluids in the steam reforming process.

### BACKGROUND

In general, process heaters used in the production of chemicals increase the temperature of fluids by radiating heat to them from the internal surfaces of large furnaces and from the combustion gas they contain. The large furnaces normally have large external surface susceptible to heat losses and significant leakage of air into or out of the furnace, where either leakage lowers thermal efficiency. Because combustion is normally performed at approximately ambient pressure, the partial pressure of carbon dioxide in the combustion products is low, causing post combustion capture of CO₂ to be more expensive and forfeiting the opportunity of producing power by expanding the combustion gas from an elevated pressure to the ambient pressure against a load.

Because furnaces provide high view factors for radiation between heat sources and heat sinks, the combustion gas normally exits the furnace at substantially higher temperature than the furnace exit temperature of the fluids they heat. Counter current heat transfer as practiced primarily in convective heat transfer heat exchangers cannot be well emulated in combustion fired radiative heat transfer furnaces, lowering the heat available to heat the furnace load.

Historically, high temperature heat transfer by radiation has enabled the practical handling of high temperature combustion products with refractory materials. One constraint of convective heat exchangers is that their materials of construction having relatively high thermal conductivity are not compatible with high flame temperatures. Both for this reason and to reduce the production of oxides of nitrogen or NOx, lower flame temperatures are needed. Newly conceived structured packings such as those taught in U.S. Pat. No. 8,235,361, enhance heat transfer coefficients while reducing the pressure drop of heat transfer. The enhancement of convective heat transfer and the use of lower flame temperatures could combine to render combustion heating by convective heat transfer feasible.

The steam methane reforming (SMR) process to react steam and a feedstock containing carbon and hydrogen at high temperature and pressure over a catalyst to form syngas containing hydrogen, carbon monoxide, and carbon dioxide is an example of a radiant zone process heater. The reactants are combustion heated in a furnace that radiates heat to tubes that contain the catalyst and in which the endothermic reforming reactions occur. To attain sufficient beam length of radiating gases to the tubes, the furnace has relatively high view factors of combustion gases in different parts of the furnace to all tube surfaces. To intensify the heat flux without overheating the tubes, the hottest combustion products are nearest the inlet or cold ends of the tubes, and the cooled combustion products exit the furnace nearest the outlet or hottest ends of the tubes. The combustion gas exits the furnace at temperatures about 150° C. higher than the syngas exiting the tubes. This co-current heat transfer is known to transfer less heat than counter current heat transfer, requiring higher firing rates and more downstream recovery of heat from the combustion products or combustion gas.

Conventional furnace practice results in a) the need for large temperature differences between the combustion products as heat sources and the reactants as heat loads, b) relatively low percentages of the combustion heat being available to the load, c) the need for major downstream recovery of heat from the exiting combustion products or flue gas, and d) the generation of more steam in the recovery of heat from the flue gas than can be consumed in the SMR process. The large temperature differences require relatively high flame temperatures resulting in higher NOx production and lost exergy, and the large downstream heat recovery requirements result in additional capital costs with additional exergy losses and the said excess steam production. Excess steam must be exported from the SMR and may have little or no monetization value.

Good furnace practice also seeks to minimize furnace fuel consumption by preheating the fuel and/or the oxidant, which oxidant is normally air. Preheating can also increase the flame temperature, which normally increases NOx production. With high combustion air preheating, additional expenses are required to lower NOx production or to remove NOx from effluents.

Large SMR furnaces normally perform combustion at atmospheric pressure and perform the reforming reaction in tubes at pressures of 15-30 bar gauge (bar-g) or higher. The extent of conversion of the reactants to syngas, favored at higher temperatures, is constrained by the temperature at which the creep strength of the tubes is sufficient for the circumferential stress on the tubes induced by the difference in pressure between the process gas and combustion gas. It would be desirable to lower that stress so reforming reactions could be performed at higher temperature and hence higher conversion.

It would be advantageous to heat fluids to higher temperatures with higher air or fuel preheating temperatures, with relatively low flame temperatures, to lower the combustion gas furnace exit or bridge wall temperature by effecting more effective counter current heat transfer, to lower NOx production, to reduce or eliminate steam export from the SMR process, to lower heat recovery expenses, and otherwise to lower the cost, size, and weight of the device by which the process fluids are heated and reacted. It would also be advantageous to convert heat to power economically and synergistically with process heaters such as hydrogen production by steam reforming and to provide waste heat for purposes external to the SMR. It would be advantageous to produce hydrogen and/or electric power in small capacity units to facilitate more effective use of waste heat as is possible with distributed production. A reader reasonably skilled in the art will observe the present invention discloses means to meet these and other objectives.

### GENERAL DESCRIPTION OF THE INVENTION

In one embodiment a source fluid is divided or separated into a first stream and a second stream, fuel and an oxidant are partially combusted with each other to create heat and a first combustion gas, heat is transferred from the first combustion gas to the first stream, one of an additional oxidant and an additional fuel is combusted with the cooled first combustion gas to create heat and form a second combustion gas, and heat is transferred from the second combustion gas to the second stream. The first and second streams may flow in parallel and may react as they are heated. The reaction may be over a catalyst. The source stream may be a mixture of steam and a gas containing carbon and hydrogen, such as a hydrocarbon, and may react over a catalyst to form syngas containing hydrogen and carbon monoxide as the mixture is heated. Preferably, the first combustion gas contains excess oxidant and additional fuel is added to form the second combustion gas. The oxidant is preferably air. The pressure of the first or second combustion gas may be greater than 5 bar-g, more preferably greater than 10 bar-g, or most preferably greater than 20 bar-g. The first or second combustion gas may be expanded to perform work on a load.

At least a component mixed to form the source fluid or a portion of the source fluid may be preheated prior to the source fluid being divided into the first and second steams against the first and second heated streams and at least one of the first and second combustion gases in a common heat exchanger.

In one embodiment air is compressed, the compressed air is partially combusted with a first fuel to form a first combustion gas, heat is transferred indirectly from the first combustion gas to a mixture of steam and a hydrocarbon whereupon the mixture reacts to form syngas containing hydrogen and carbon monoxide, the first combustion gas is at least partially combusted with a second fuel to form a second combustion gas, and the second combustion gas is expanded to perform work on a load.

In one embodiment the pressure of the first combustion gas or second combustion gas is less than 5 bar greater than and less than 5 bar less than the pressure of the first stream. More preferably the pressure of the first or second combustion gas is less than 2 bar higher and less than 2 bar lower than the pressure of the first stream.

The heat transfer may be indirect, primarily by convection, and/or may be counter current. The heat transfer may be performed in a heat exchanger having a flow pattern or a structure as is taught in U.S. Pat. No. 8,235,361 or U.S. provisional patent application 63/316,103, which are incorporated by reference in their entirety.

In one embodiment air used in combustion heating undergoes at least two cycles in sequence, each cycle consisting of a) at least partially combusting with a fuel and b) passing through a counter current heat exchanger wherein the at least partially combusted air transfers heat to a load. The load may be a fluid.

In one embodiment air is sequentially compressed, at least partially combusted with a fuel to create a first combustion gas, the first combustion gas is passed through a counter current heat exchanger wherein the first combustion gas transfers heat to a load, the first combustion gas is at least partially combusted with a fuel to form a second combustion gas, and the second combustion gas is expanded to perform work on a load.

U.S. Pat. No. 7,752,848 is cited as relevant prior art.

### BRIEF DESCRIPTION OF THE DRAWINGS

FIG. 1 shows a schematic of the present disclosure according to one embodiment.

### DETAILED DESCRIPTION OF THE INVENTION

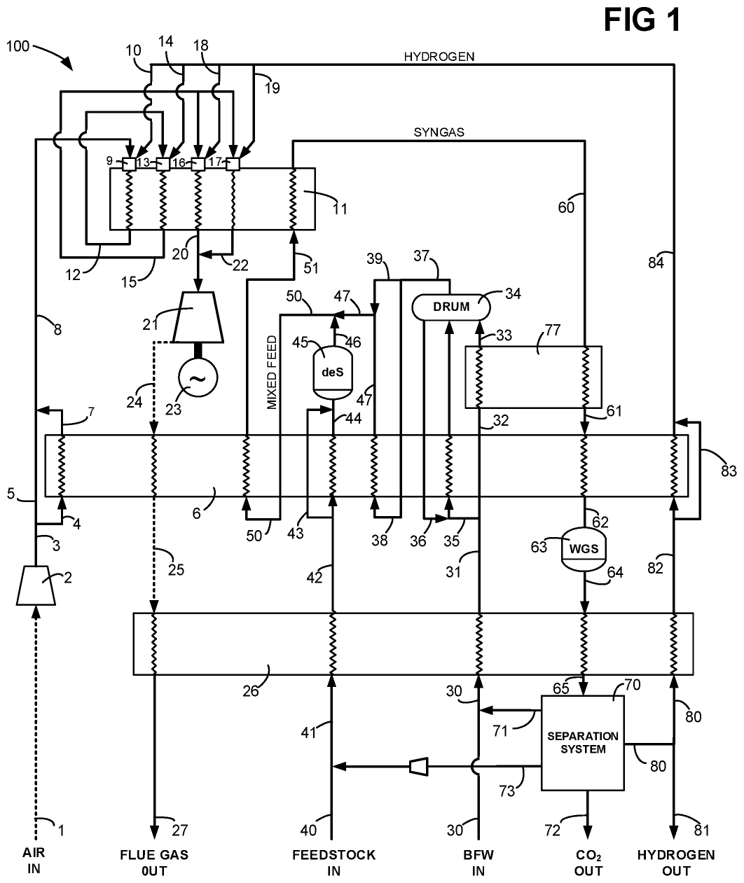

Referring to FIG. 1, line 1 conveys air to compressor 2 wherein the air is compressed. Line 3 conveys the compressed air from the compressor to lines 4 and 5. Line 4 conveys some of the air from line 3 to counter current convective heat exchanger 6 wherein the air is heated against combustion products from line 24 and syngas from line 61. Line 7 conveys the heated air from heat exchanger 6 to line 8 wherein it mixes with bypass air from line 5. Line 5 conveys some of the air from line 3 to line 8 wherein it mixes with heated air from line 7.

Line 8 conveys air from lines 5 and 7 to combustion device 9 wherein some of the air combusts with fuel from line 10. Combustion products from device 9 pass through counter current convective heat exchanger 11 wherein the combustion products are cooled and against mixed feed from line 51.

Line 12 conveys cooled combustion products from device 9 and heat exchanger 11 to combustion device 13 wherein at least some of the air combusts with fuel from line 14. Combustion products from device 13 pass through heat exchanger 11 wherein the combustion products are cooled against mixed feed from line 51.

Line 15 conveys cooled combustion products from device 13 and heat exchanger 11 to combustion devices 16 and 17. Some of the air from line 15 combusts in device 16 with fuel from line 18. Combustion products from device 16 pass through heat exchanger 11 wherein the combustion products are cooled against mixed feed from line 51. Some of the air from line 15 combusts in device 17 with fuel from line 19. Combustion products from combustion device 17 pass through heat exchanger 11 wherein the combustion products are cooled against mixed feed from line 51. The product of the heat transfer surface area (A) times the heat transfer coefficient (U), (i.e., the UA), between combustion products from device 16 and mixed feed from line 51 is greater than the UA between the combustion products from device 17 and mixed feed from line 51.

Line 20 conveys combustion products from combustion device 16 and heat exchanger 11 to expander 21 wherein the combustion products are expanded. Line 22 conveys combustion products from device 17 and heat exchanger 11 to expander 21 wherein the combustion products are expanded. The expander performs work on load 23.

The temperatures of the combustion products in lines 12 and 15 are preferably as low as possible. The temperature of combustion products in lines 21 and 22 may be higher than the temperatures of combustion products in lines 12 or 15.

Line 24 conveys expanded combustion products from the expander to convective counter current heat exchanger 6 wherein they are cooled against air from line 4, feedstock from line 42, boiler feed water or steam from lines 35 and 38, mixed feed from line 50, and hydrogen from line 82.

Line 25 conveys cooled combustion products from heat exchanger 6 to counter current convective heat exchanger 26 wherein they are cooled against feedstock from line 41, boiler feed water from line 30, and hydrogen fuel from line 80. Line 27 conveys combustion products from heat exchanger 26 and from steam reforming system 100.

Line 30 conveys boiler feed water to heat exchanger 26 wherein it is heated against combustion products from line 25 and syngas from line 64. Line 31 conveys heated water and/or steam from heat exchanger 26 to lines 32 and 35. Line 32 conveys water and/or steam from line 31 directly to heat exchanger 77 wherein it is vaporized against syngas from line 60. Line 33 conveys steam from heat exchanger 77 to steam drum 34 wherein water and steam are separated from each other. Line 35 conveys water and/or steam from line 31 to heat exchanger 6 wherein it is vaporized against combustion products from line 24 and syngas from line 61. Line 36 conveys water from the drum to line 35 wherein it mixes with the water and/or steam in line 35.

Line 37 conveys steam from the drum to lines 38 and 39. Line 38 conveys steam from line 37 to heat exchanger 6 wherein it is heated against combustion products from line 24 and syngas from line 61. Line 39 conveys steam from line 37 to line 47 wherein it mixes with steam from line 38.

Line 40 conveys feedstock to line 41 wherein it mixes with recycle gas from line 73. Line 41 conveys feedstock from line 40 and recycle gas from line 73 to heat exchanger 26 wherein it is heated against combustion products from line 25 and syngas from line 64. Line 42 conveys heated feedstock from heat exchanger 26 to line 43 and to heat exchanger 6 wherein feedstock is heated against combustion products from line 24 and syngas from line 61. Line 44 conveys feedstock from heat exchanger 6 and from line 43 to desulfurization unit 45 wherein the feedstock is desulphurized. Line 43 conveys feedstock from line 42 directly to line 44 without passing through heat exchanger 6. Line 46 conveys desulphurized feedstock from unit 45 to line 50 wherein the feedstock mixes with steam from line 47. Line 47 conveys steam from heat exchanger 6 and from line 39 to line 50 wherein the steam mixes with feedstock from line 46 to form a mixed feed.

Line 50 conveys mixed feed formed from steam from line 47 and feedstock from line 46 to heat exchanger 6 wherein the mixed feed is heated against combustion products from line 24 and syngas from line 61. Line 51 conveys the heated mixed feed from heat exchanger 6 to heat exchanger 11 wherein the mixed feed is divided into multiple, parallel streams which streams are respectively heated and reacted over a catalyst to form syngas against combustion products from devices 9, 13, 16, and 17.

Line 60 conveys syngas from heat exchanger 11 to heat exchanger 77 wherein it is cooled against water from line 32. Line 61 conveys cooled syngas from heat exchanger 77 to heat exchanger 6 wherein the syngas is cooled against air from line 4, water and/or steam from lines 35 and 38, feedstock from line 42, mixed feed from line 50, and hydrogen fuel from line 82. Line 62 conveys cooled syngas from heat exchanger 6 to water gas shift reactor 63 wherein some of the steam and carbon monoxide in the syngas react to form additional hydrogen and carbon dioxide. Line 64 conveys the shifted syngas from unit 63 to heat exchanger 26 wherein the syngas is cooled against water from line 30, feedstock from line 41, and hydrogen fuel from line 80. Line 65 conveys the cooled syngas from heat exchanger 26 to separation system 70 wherein the syngas is separated into a hydrogen rich stream, a carbon dioxide stream, a water stream, and a recycle stream.

Line 71 conveys the water stream from system 70 to line 30. Line 72 conveys the carbon dioxide stream from system 70 and from reforming system 100. Line 80 conveys the hydrogen rich stream from system 70 to line 81 and to heat exchanger 26 wherein the hydrogen is heated against combustion products from line 25 and syngas from line 64. Line 73 conveys recycle gas from system 70 to line 41 wherein it mixes with feedstock from line 40.

Line 81 conveys hydrogen from line 80 and from reforming system 100.

### Operation

The inlet flow of feedstock through line 40 is adjusted to provide a prescribed flow of hydrogen product exiting line 81. The inlet flow of boiler feed water in line 30 is adjusted to provide a prescribed ratio of the molar flow rate of steam in line 30 to the molar flow rate of carbon atoms in line 41 or the prescribed S/C ratio. A S/C ratio in the range of 2.0 to 2.5 is preferred.

The feedstock flow rate through bypass line 43 is adjusted to cause the temperature of the combined feedstock in line 44 to enter unit 45 at a prescribed temperature suitable for desulphurization, such as 380° C., for example.

The flow of water and/or steam in bypass line 32 is adjusted to cause the syngas temperature in line 62 to be suitable for entry into the water gas shift unit 63, such as a temperature in the range of 200° C. to 350° C. The water gas shift unit may contain a high temperature shift reactor, means for cooling the syngas exiting the high temperature shift reactor, and a low temperature shift reactor. The UA between the syngas from line 61 and the fluids in lines 4, 50, 42, 35, 38, and 82 is adjusted to cause the syngas temperature from line 61 to be less than 600° C. to avoid rapid metal dusting corrosion of system 100. The flow rates of air in bypass line 5 and hydrogen fuel in bypass line 83 are adjusted to minimize the temperatures of the combustion gas in line 25.

The hydrogen fuel flow rate in line 82 is adjusted to provide stoichiometric combustion of the air from line 1. The air flow rate in bypass line 5 is adjusted to provide a syngas temperature of 850° C. in line 60. The flow rates of hydrogen in lines 10. 14, 18, and 19 are adjusted to provide adiabatic flame temperatures of 950° C. in devices 9, 13, 16, and 17. The UA between combustion gases and mixed feed in heat exchanger 11 are designed to cause the temperatures of combustion gases in lines 12, 15, and 20 to be 80° C. greater and preferably 20° C. greater than the mixed feed temperature in line 51. The UA between the combustion gas from device 17 and the mixed feed from line 51 is designed to cause the combined combustion gases from lines 20 and 22 to be suitable for inlet to the expander, such as in the range of 700° C. to 800° C.

The adjusted flow rates are determined by closed loop control of the prescribed product hydrogen flow in line 81, S/C ratio, and intermediate temperatures. The optimal combination of adjusted flow rates is determined by a computer process simulation model.

The water gas shift unit is designed to provide a suitably low exit temperature and approach to equilibrium of the syngas in line 64.

The pressures of the combustion gas in line 15 and the mixed feed in line 51 are adjusted to 30 bar-g.

Separation unit 70 causes at least 95% and preferably at least 99% of the carbon dioxide in line 65 to flow to line 72 and at least 95% and preferably at least 98% of the hydrogen in line 65 to flow to line 80. Unit 70 is designed to cause at least a portion of the nitrogen content in line 65 to flow to outlet lines from unit 70 other than 71 and 73.

The combustion devices may be upstream of heat exchanger 11 or may be contained in heat exchanger 11. The heat exchangers are preferably multi-annular heat exchangers as taught in U.S. provisional patent application 63/316,103.

I claim:

1. A method of heating a source fluid wherein
a. the source fluid is separated into a first stream and a second stream,
b. fuel and an oxidant are partially combusted to create heat and a first combustion gas,
c. heat is transferred from the first combustion gas to the first stream,
d. one of an additional oxidant and an additional fuel is combusted with the cooled first combustion gas to create heat and form a second combustion gas,
e. and at least some heat is transferred from the second combustion gas to the second stream.

2. The method of claim 1 wherein the first and second streams flow in parallel and react over a catalyst as they are heated.

3. The method of claim 1 wherein the source stream is a mixture of steam and a gas containing carbon and hydrogen which react to form syngas containing hydrogen and carbon monoxide as the first stream is heated.

4. The method of claim 1 wherein the oxidant is air, the fuel is hydrogen, the first combustion gas contains excess oxidant, and additional fuel is added to the first combustion gas to form the second combustion gas.

5. The method of claim 1 wherein the pressure of at least one of the first combustion gas and second combustion gas is greater than 5 bar-g.

6. The method of claim 1 wherein the first or second combustion gas is expanded to perform work on a load.

7. The method of claim 1 wherein at least a portion of the source fluid is preheated prior to the source fluid being divided into the first and second streams and in a common heat exchanger against a) the first and second heated streams and b) at least one of the first and second combustion gases.

8. The method of claim 1 wherein the pressure of at least one of the first combustion gas and second combustion gas is less than 5 bar greater than and less than 5 bar less than the pressure of the first stream.

9. A method of heating a fluid and producing power wherein
a. air is compressed,
b. the compressed air is partially combusted with a first fuel to form a first combustion gas,
c. heat is transferred indirectly from the first combustion gas to the fluid,
d. the first combustion gas is at least partially combusted with a second fuel to form a second combustion gas, and
e. the second combustion gas is expanded to perform work on a load.
